(19) United States
(12) Patent Application Publication
(10) Pub. No.: US 2007/0146787 A1
(43) Pub. Date: Jun. 28, 2007

(54) Image processing history management apparatus

(75) Inventor: Tetsunori Murakami, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 11/450,346

(22) Filed: Jun. 12, 2006

(30) Foreign Application Priority Data
Dec. 21, 2005 (JP) P2005-368116
Dec. 21, 2005 (JP) P2005-368117

(51) Int. Cl. G06K 15/00

(52) U.S. Cl. 358/1.16

(57) ABSTRACT

An image processing history management apparatus managing image processing history of an image processing apparatus, the image processing history management apparatus includes: a storage unit that stores image data processed in the connected image processing apparatus; a classification unit that classifies the stored image data into groups based on a grouping condition; and a unit to output the classified groups.

### BACKGROUND

1. Technical Field

This invention relates to an image processing history management apparatus for managing an image processing history in an image processing apparatus such as a copier, a scanner, a facsimile, or a printer.

2. Related Art

In recent years, an art of retaining a history of image data processed in an image processing apparatus such as a copier or a printer, thereby making it possible to track the processing date and time and the processing instruction person of specific image data has been available.

### SUMMARY

According to an aspect of the present invention, an image processing history management apparatus managing image processing history of an image processing apparatus, the image processing history management apparatus includes: a storage unit that stores image data processed in the connected image processing apparatus; a classification unit that classifies the stored image data into groups based on a grouping condition; and a unit to output the classified groups.

According to another aspect of the present invention, an image processing history management apparatus managing image processing history of an image processing apparatus, the image processing history management apparatus includes: a storage unit that stores image data processed in the image processing apparatus; a classification unit that classifies the stored image data into groups based on a grouping condition; and a selection unit that selects representative image data from among image data contained in each of the groups and provides the selected representative image data for each of the groups.

### BRIEF DESCRIPTION OF THE DRAWINGS

FIG. 1 is a block diagram to show the configuration of a system including an image processing history management apparatus according to an embodiment of the invention;

FIG. 2 is a schematic representation to show an example of processing history information recorded by the image processing history management apparatus according to the embodiment of the invention;

FIG. 3 is a flowchart to show an example of processing executed by the image processing history management apparatus according to the embodiment of the invention;

FIG. 4 is a schematic representation to show a screen example of the search result provided by the image processing history management apparatus according to the embodiment of the invention; and

FIG. 5 is a schematic representation to show another screen example provided by the image processing history management apparatus according to the embodiment of the invention.

### DETAILED DESCRIPTION OF THE INVENTION

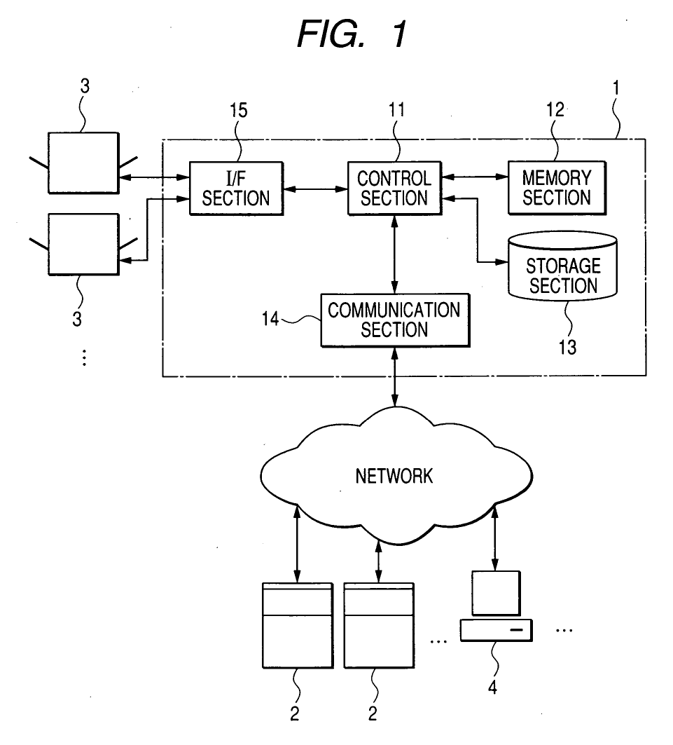

Referring now to the accompanying drawings, there is shown an embodiment of the invention. An image processing history management apparatus according to the embodiment of the invention is implemented as a server 1 connected to image processing apparatus such as plural copiers 2, plural printers 3, a scanner (not shown), and a facsimile (not shown) and a personal computer (PC) 4, for example, as shown in FIG. 1. The server 1 as the image processing history management apparatus of the embodiment is made up of a control section 11, a memory section 12, a storage section 13, a communication section 14, and an interface (I/F) section 15, as shown in FIG. 1.

The control section 11 is a CPU, etc., and operates in accordance with a program stored in the memory section 12. The control section 11 receives image data to be processed from the copier 2, the PC 4, etc., and supplementary information such as information identifying the user making a processing request of the image data and stores processing history information including them in the storage section 13. The control section 11 also transmits the received image data to be processed to an image processing apparatus of the copier 2, the printer 3, etc., and causes the image processing apparatus to execute image processing.

The control section 11 also receives a processing history information search instruction and executes search processing of searching for the processing history information stored in the storage section 13 and presents the search result. The processing of the control section 11 is described later in detail.

The memory section 12 is made up of memory devices of RAM, ROM, etc. The programs executed by the control section 11 are stored in the memory section 12. The memory section 12 also operates as work memory of the control section 11. The storage section 13 is a hard disk unit, etc., and retains processing history information in accordance with an instruction input from the control section 11.

The communication section 14 is, for example, a network card and transmits data to the specified destination through a network in accordance with an instruction input from the control section 11. The communication section 14 receives data coming through the network and outputs the data to the control section 11.

The I/F section 15 is a serial bus interface, such as a USB (Universal Serial Bus), and is connected to the printers 3. The I/F section 15 outputs image data to the printer 3 in accordance with an instruction input from the control section 11.

Each copier 2 is connected to the server 1 through the network. When the user enters a copy instruction, the copier 2 transmits the image data read in accordance with the copy instruction to the server 1. At this time, the copier 2 may request the user entering the copy instruction to enter the user name and the password for authentication and may transmit the information identifying the user (the user name, etc.,) obtained by the authentication to the server 1 together with the image data.

The copier 2 does not perform formation processing of is the read image data on paper and receives the image data to which formation processing is applied from the server 1 and forms the received image data on paper. That is, in the embodiment, the image data provided by reading the original to be copied is once transmitted to the server 1 and processing is continued based on the image data received from the server 1.

Each printer 3 is connected to the server 1 through serial bus interface, etc., and forms image data input from the server 1 on a medium such as paper. The PC 4 is connected to the server 1 through the network and transmits the image data to be printed on the printer 3 and the supplementary information of the user name of the user entering the processing instruction, etc., to the printer 3 through the server 1.

In scanners, facsimiles, etc., the read image data to be processed and the information of the user name, etc., obtained by authentication are also transmitted to the server 1 of the embodiment.

The operation of the control section 11 of the server 1 is as follows: The control section 11 records an image processing history in each connected image processing apparatus. That is, the control section 11 receives image data involved in processing and supplementary information from the image processing apparatus such as the copier 2, the PC 4 requesting the image processing apparatus to perform image processing, etc.

The image data may be bit map data or may be data described in a PDL (page description language) such as postscript (registered trademark). If the supplementary information is an image processing instruction given to the printer 3, it may contain information of the user name of the user giving the processing instruction, the name of the data file (path name, etc.,) of the source of the image data, the number of the formation processing page, the number of print copies, etc.

If the supplementary information relates to copy in the copier 2, it may contain information of the user name of the user giving the instruction and the number of copies and parameters concerning generation of image data such as original specification (text, mixing of text and photo, or photo), etc., at the read time through a scanner, etc.

Upon reception of the image data and the supplementary information, the control section 11 issues a unique history identifier (which may be a serial number) and acquires date and time information at the point in time from a calendar section (not shown).

[Image Processing Instruction to Printer]

If the received image data relates to an image processing instruction in the printer 3, the control section 11 extracts the name of the data file of the source of the image data contained in the supplementary information and checks whether or not the image data instructed to be processed as the source in the data file of the same name as the extracted name is already stored in the storage section 13 as processing history information. If the image data instructed to be processed as the source in the data file of the same name as the extracted name is already stored in the storage section 13 as processing history information, namely, if an image processing instruction was given based on the same data file in the past, the control section 11 acquires the history identifier of the processing history information already stored in the storage section 13 as relevant history information.

Further, in the embodiment, the control section 11 combines the code image representing the issued history identifier with the image data involved in the image processing instruction given to the printer 3 to produce image data, and outputs this image data to the printer 3. Accordingly, the printer 3 prints out the image data provided by combining the history identifier with the image data from the PC 4. Here, the code image may be a bar code, etc., for example. If watermark print is possible, the code image may be printed as an electronic watermark. Further, if an RFID tag is put on paper, the code image may be recorded in the RFID.

The control section 11 stores the history identifier, the acquisition date and time information, the image data, the supplementary information, and the relevant history information in the storage section 13 in association with each other as new processing history information.

[Image Processing Instruction in Copier]

On the other hand, if the received image data relates to copy image processing instruction in the copier 2, the control section 11 checks whether or not the received image data contains the code image processed in the printer 3 (code image describing the history identifier identifying the processing history information). If the code image is contained, the control section 11 decodes the code image and acquires the history identifier as the relevant history information. To put an RFID tag on paper for record, information in the RFID may be read in the copier 2 and may be transmitted to the server 1 and the control section 11 may check whether or not the information contains the history identifier and if the history identifier is contained, the control section 11 may acquire the history identifier as the relevant history information.

The control section 11 stores the history identifier, the acquisition date and time information, the image data, the supplementary information, and the relevant history information in the storage section 13 in association with each other as new processing history information.

Further, the control section 11 combines the code image representing the issued history identifier with the received image data involved in the image processing instruction given to the printer 3 with the detected code image overwritten to produce image data, and outputs this image data to the copier 2.

When the image data and the supplementary information are thus received from the copier 2 or the PC 4, etc., if the received image data is bit map image data, the control section 11 may perform optical text recognition processing to extract the contained character string data; if the received image data is data described in a PDL, the control section 11 may extract character string data from the data. The control section 11 may perform index creation processing based on the extracted character string data and may associate the data with the image data with the created index as keyword data for storage in the storage section 13.

The index creation processing is similar to that in general full-text search processing, for example, and refers to processing of dividing character string data into words by performing morphological analysis processing, etc., computing the occurrence frequency (Tf) of each word contained in a predetermined word list, and taking out the first to Nth words in the descending order of the occurrence frequencies as keywords or the like. In addition, the reciprocal of occurrence frequency (Idf) in plural documents may be used together.

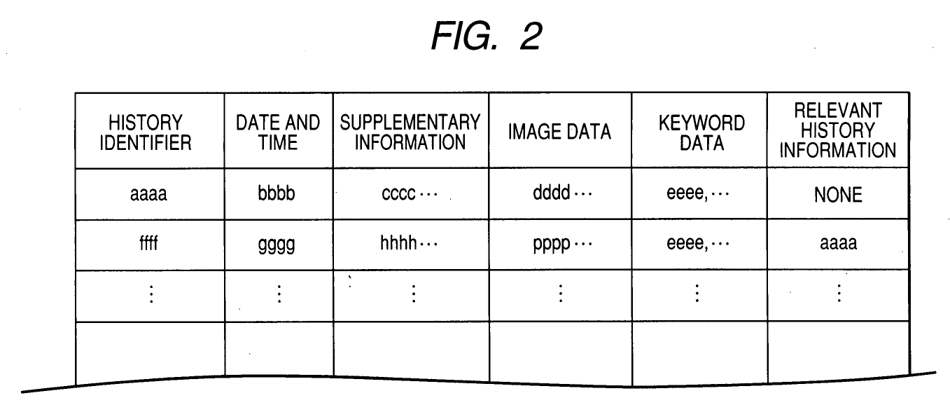

Accordingly, plural pieces of processing history information are retained in the storage section 13 and the supplementary information (user name, etc.,), the image data, and the keyword data as well as the history identifier and date and time information are associated with each piece of the processing history information, as shown in FIG. 2. If relevant history information exists, further the relevant history information is also associated with each piece of the processing history information for retention.

Thus, in the embodiment, the control section 11 combines the code image describing the history identifier identifying the corresponding processing history information with each image to be formed in the printer 3 and each image to be formed in the copier 2. Accordingly, the processing history information pieces are grouped.

[Image Processing in Scanner, Facsimile, Etc.]

Further, the control section 11 also performs similar processing for image data read in a scanner or a facsimile. That is, the control section 11 checks whether or not the image data received from a scanner, a facsimile, etc., contains a code image (code image describing the history identifier identifying the processing history information). If the code image is contained, the control section 11 decodes the code image and acquires the history identifier as the relevant history information. To put an RFID tag on paper for record, information in the RFID may be read in the scanner or the facsimile and may be transmitted to the server 1 and the control section 11 may check whether or not the information contains the history identifier and if the history identifier is contained, the control section 11 may acquire the history identifier as the relevant history information.

The control section 11 stores the history identifier, the acquisition date and time information, the image data, the supplementary information, and the relevant history information in the storage section 13 in association with each other as new processing history information.

[Search Processing]

Next, the search processing of the control section 11 will be discussed. The control section 11 receives a processing history information search instruction together with a search condition from the PC 4, etc., and outputs the processing history information satisfying the specified search condition from the processing history information stored in the storage section 13.

The search condition received from the PC 4 is a condition for searching for the image data associated with the specified keyword. The control section 11 searches the storage section 13 for the processing history information containing the keyword specified according to the received search condition as the keyword data.

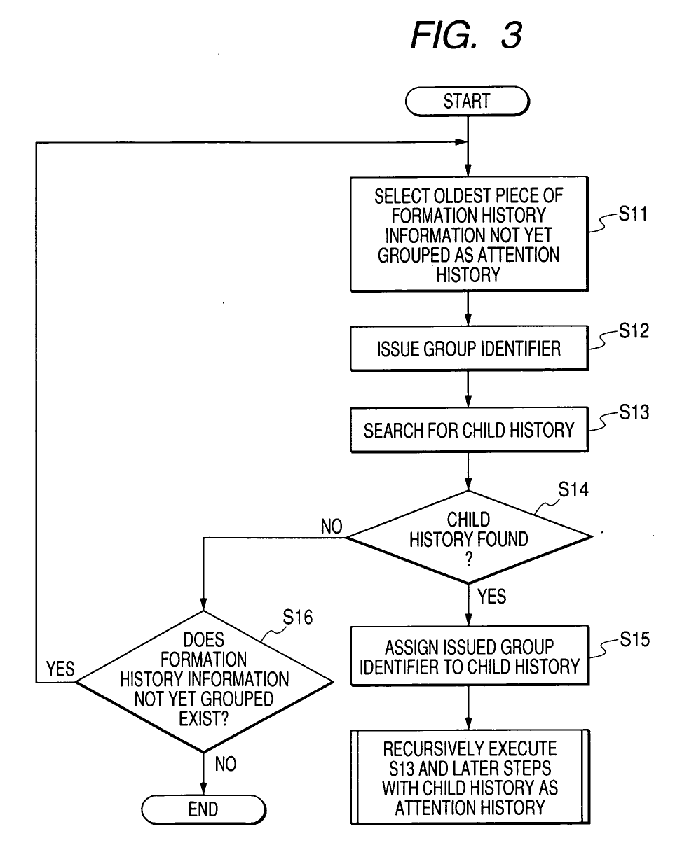

The control section 11 stores a list of pieces of processing history information obtained as the search result (called search list) in the memory section 12 and starts integration processing shown in FIG. 3. In the integration processing, a common group identifier is assigned to the pieces of processing history information associated with each other using the fact that the pieces of processing history information are associated with each other (associated according to relevant history information) as a grouping condition.

That is, the control section 11 first selects the processing history information piece recorded in the oldest past in the date and time information order (processing date and time order) and not yet assigned a group identifier as an attention history from among the pieces of processing history information contained in the search list (S11). The control section 11 issues a unique group identifier and stores the issued group identifier in the memory section 12 in association with the attention history (S12) and assigns the group identifier to the attention history.

Next, the control section 11 searches the search list for the processing history information containing the history identifier of the attention history as relevant history information and containing the date and time information after the date and time of the attention history (called child history) (S13). The control section 11 determines whether or not a child history is found (S14). If a child history is found, the control section 11 assigns the group identifier assigned to the attention history to each child history (S15) and further executes S13 and the later steps recursively with each child history as the attention history.

When no child history is found in step S14, namely, when assigning of the common group identifier to a group of pieces of processing history information associated with each other is complete, the control section 11 determines whether or not processing history information not yet assigned any group identifier is contained in the search list (S16). If processing history information not yet assigned any group identifier is contained in the search list (YES at S16), the process returns to step S11 and the processing is continued. If processing history information not yet assigned any group identifier is not contained in the search list (NO at S16), namely, if assigning of the group identifier to all pieces of processing history information contained in the search list is complete, the processing is terminated.

The control section 11 provides a representative history list for each group identifier with the oldest (date and time information is the oldest) processing history information as a representative history for each processing history information group assigned the same group identifier.

The control section 11 may operate as a web server, for example, and may transmit an HTML document describing the representative history list (list of thumbnail images of image data contained in the representative histories) to the PC 4, etc., of the search requester. Further, in this case, the number of pieces of processing history information assigned for each group identifier may be presented in association with the representative history.

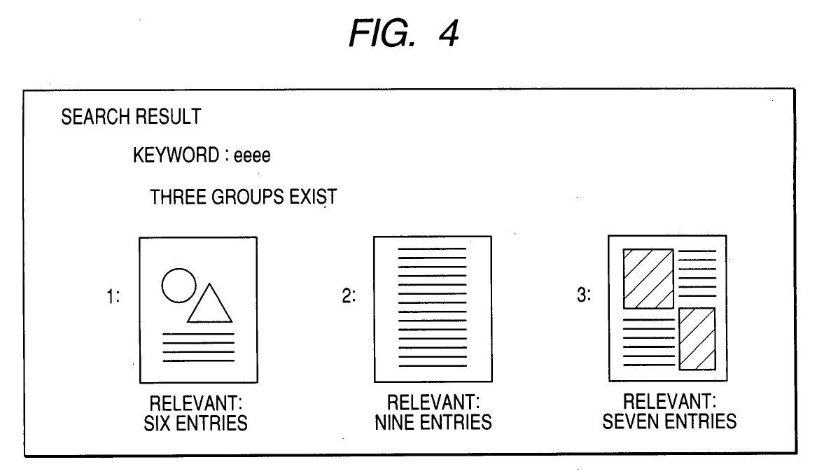

As the processing is performed, the PC 4 making the search processing request is provided with the processing history information pieces grouped for each piece of image data associated with each other (subjected to print processing from the same data file or copying the same original), for example, as shown in FIG. 4. A history identifier list of the processing history information contained in each group containing the representative history may be associated with each thumbnail image. If the user clicks on one of the thumbnail images, an instruction to generate an HTML document describing a list of the processing history information pieces determined according to the history identifier list may be transmitted.

In this case, if the user clicks on any thumbnail image of representative history on the screen illustrated in FIG. 4, an instruction to generate a list of the processing history information pieces belonging to the group containing the representative image is transmitted to the server 1. The control section 11 of the server 1 extracts the processing history information pieces determined according to the history identifier contained in the instruction from the storage section 13, generates an HTML document presenting a list of the date and time information, the user names, the image data, etc., of the extracted processing history information pieces, and sends the HTML document to the PC 4.

In the description given so far, if the data files of the sources of the image data are common or are in the relationship of original and copy, they are assumed to be image data associated with each other. Thus, for example, the history identifier of the past processing history information with the data file name common to the sources of the image data is recorded as relevant history information. However, the data file may be corrected, etc., and they may not necessarily be associated with each other. Then, in the embodiment, the following processing is performed:

The PC 4 transmitting an image processing instruction to the printer 3 transmits the last update date and time of the data file of the source of the image data (generally the last update date and time can be acquired from information in a file system of an operating system) as supplementary information to the server 1.

The control section 11 extracts the name of the data file of the source of the image data and the last update date and time contained in the supplementary information. When relevant history information is acquired, information Tp of the last update date and time contained as the supplementary information in the processing history information determined by the relevant history information is acquired and is compared with information Tx of the last update date and time contained in the received supplementary information. If acquired Tp and Tx differ, information to the effect that they differ (attention information) is generated and is contained in processing history information for storage in the storage section 13.

Further, a comparison is made between the received image data and the image data contained in the processing history information determined by the relevant history information and if the difference therebetween is larger than a predetermined criterion, attention information may be generated and may be contained in processing history information for storage in the storage section 13. Here, the image data pieces may be compared as the difference between the image data pieces is computed, for example.

If the received image data relates to copy image processing in the copier 2, when relevant history information is acquired, a comparison may be made between the received image data and the image data contained in the processing history information determined by the relevant history information and if the difference therebetween is larger than a predetermined criterion, attention information may be generated and may be contained in processing history information for storage in the storage section 13.

In addition, the attention information may be contained in processing history information if the difference portion amount of data of the character string extracted from image data exceeds a predetermined threshold value, for example.

When the processing history information contained in the search list is divided into groups in the search processing, if the processing history information associated with the common group identifier contains processing history information containing the attention information, the control section 11 may output information indicating that the processing history information containing the attention information exists in the group when presenting the thumbnail images of the representative histories.

When a list of pieces of processing history information contained in one group is displayed, the processing history information containing the attention information may be displayed in a mode in which it can be distinguished from the processing history information containing no attention information.

Further, when a list of pieces of processing history information contained in one group is displayed, only the processing history information containing no attention information may be selectively displayed.

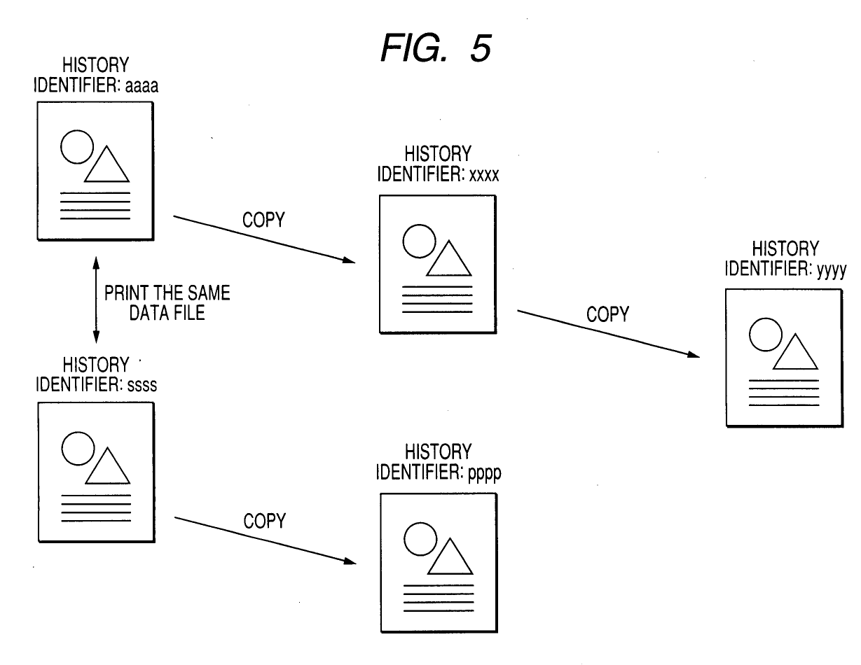

Further, for each group, an image illustrating the relationship between the processing history information pieces contained in the group as a graph may be generated and provided for the PC 4 (for example, FIG. 5). Such a graph image can be generated using an art widely known as an art of graphing and illustrating a link like the processing history information.

The entire disclosure of Japanese Patent Applications No. 2005-368116 and No. 2005-368117 filed on Dec. 21, 2005 including specifications, claims, drawings and abstracts are incorporated herein by reference in its entirety.

What is claimed is:

1. An image processing history management apparatus managing image processing history of an image processing apparatus, the image processing history management apparatus comprising:
a storage unit that stores image data processed in the connected image processing apparatus;
a classification unit that classifies the stored image data into groups based on a grouping condition; and
a unit to output the classified groups.

2. The image processing history management apparatus according to claim 1, wherein
the classification unit classifies image data, names of data file of the image data are common, into a same group.

3. The image processing history management apparatus according to claim 1, wherein
the output unit outputs a group that includes image data, last update date or time of data file of which differ from each other, and a group that does not include image data, last update date or time of data file of which differ from each other, differently.

4. An image processing history management apparatus managing image processing history of an image processing apparatus, the image processing history management apparatus comprising:
a storage unit that stores image data processed in the image processing apparatus;
a classification unit that classifies the stored image data into groups based on a grouping condition; and
a selection unit that selects representative image data from among image data contained in each of the groups and provides the selected representative image data for each of the groups.

5. A control method of an image processing history management apparatus managing image processing history of an image processing apparatus, the control method comprising:
storing image data processed in the image processing apparatus;
classifying the stored image data into groups based on a grouping condition; and
outputting the classified groups.

6. The control method of the image processing history management apparatus according to claim 5, wherein
the image data are classified into groups in which names of data file of the each image data are common.

7. The control method of the image processing history management apparatus according to claim 5, wherein
a group that includes image data, last update date or time of data file of which differ from each other, and a group that does not include image data, last update date or time of data file of which differ from each other, are outputted differently.

8. A control method of an image processing history management apparatus managing image processing history of an image processing apparatus, the control method comprising:
storing image data processed in the image processing apparatus;
classifying the stored image data into groups based on a grouping condition; and
selecting representative image data from among image data contained in each of the groups and providing the selected representative image data for each of the groups.

9. A storage medium readable by a computer, the storage medium storing a program of instructions executable by the computer to perform a function for controlling an image processing history management apparatus managing image processing history of an image processing apparatus, the function comprising:
storing image data processed in the image processing apparatus;
classifying the stored image data into groups based on a grouping condition; and
outputting the classified groups.

10. The storage medium storing the program according to claim 9, wherein
the image data are classified into groups in which names of data file of the each image data are common.

11. The storage medium storing the program according to claim 9, wherein
a group that includes image data, last update date or time of data file of which differ from each other, and a group that does not include image data, last update date or time of data file of which differ from each other, are outputted differently.

12. A storage medium readable by a computer, the storage medium storing a program of instructions executable by the computer to perform a function for controlling an image processing history management apparatus managing image processing history of an image processing apparatus, the function comprising the steps of:
storing image data processed in the image processing apparatus;
classifying the stored image data into groups based on a grouping condition; and
selecting representative image data from among image data contained in each of the groups and providing the selected representative image data for each of the groups.
